(19) United States
(12) Patent Application Publication
(10) Pub. No.: US 2025/0278790 A1
(43) Pub. Date: Sep. 4, 2025

(54) TRANSIT ASSET UTILITY PLANNING FOR CIRCULARITY BASED ON PERFORMANCE

(71) Applicant: HITACHI, Ltd., Tokyo (JP)

(72) Inventors: Malarvizhi SANKARANARAYANASAMY, Mountain View, CA (US); Ravigopal VENNELAKANTI, San Jose, CA (US)

(21) Appl. No.: 18/593,756

(22) Filed: Mar. 1, 2024

(51) Int. Cl. G06Q 40/06; G06Q 10/1093; G06Q 10/20

(52) U.S. Cl. CPC G06Q 40/06; G06Q 10/1093; G06Q 10/20

(57) ABSTRACT

Systems and methods for management of a plurality of assets, involving a) executing a machine learning model to generate operational scenario-based event prediction from survival maps of the plurality of assets, historical data for the plurality of assets, and attributes of interest; b) receiving, from a plurality of stakeholders of the plurality of assets, weighted parameters for the attributes of interest associated with the operational-scenario-based event prediction; c) iterating a) and b) until a circularity decision is generated for the plurality of assets; and d) executing the circularity decision on the plurality of assets.

### BACKGROUND

### Field

The present disclosure is generally directed to asset management frameworks.

### Related Art

Asset management systems offer a framework for decision-making that is driven by performance objectives with a broad time horizon, encompassing economics and engineering, and that takes a range of assets into account. Since transit systems are a part of the public and social infrastructure, system management and investment goals are intrinsically linked with user expectations for system availability, performance, and condition. The fundamental objective of asset management is to select programming alternatives and resource allocation techniques that will increase system value and overall user satisfaction by improving program efficiency and system performance. This makes it possible for managers in charge of day-to-day operations, representatives of the government, system users, and other stakeholders to have a fact-based conversation.

Circularity has gained popularity because of the current rise in environmental consciousness and legislative directives influenced by the right to repair, economics, and material constraints (particularly with assets geared toward electric vehicles). The present policy directions (Bi-partisan Infrastructure Bill) have also given Department of Transportations (DoTs) across the United States the chance to rebuild their asset profiles with electric vehicles and related infrastructure. Transit assets, as previously indicated, require long-term planning, which involves creating end-of-life policies by DoTs and private transit operators and planning for circularity.

Projecting asset survival on short- and long-term utility and planning for re-allocation is one of the key elements of circularity planning.

Related art transportation asset management frameworks are mostly focused on lifecycle cost assessment and estimating factorial risk impact on the standard minimum set of conditions prescribed by the regulatory bodies. Life cycle cost analysis models usually involve only design time attribute and provide project level analysis. These framework setups provide hardly any visibility into asset network level activity and are not updated. Further the forecast is limited to know set of pre-existing asset configuration without visibility to actual ground configuration.

In the related art, there is a dependability assessment framework for railroad asset management. Using probabilistic graphical models, such a related art implementation provides scenario-based risk assessment for asset management that considers all system components, including the people and process inputs.

In the related art, there is resource allocation and risk modeling for geographically distributed assets. Such a related art implementation offers a variable resolution grid method for calculating the risk exposure to a collection of moveable and immovable assets that are spread out geographically.

In the related art, there is optimizing state transition set points for schedule risk management. Such a related art implementation provides decision support specifically for scheduling taking in health care setting based on the cumulative probability distribution upper and lower limit estimates to assign tasks incrementally.

### SUMMARY

Since these are new infrastructures/assets, a prior does not exist within many organizations. Hence the decision-making framework, such as capital allocation planning needs to be made on limited/no prior information.

Further, asset performance characteristics need to be matched to current usage/existing travel (behavior) models of the organization/location.

In addition, the circularity planning requires survival projections and future usage scenarios based on existing infrastructure/maps.

Example implementations described herein involve the planning stage of asset management, focusing more specifically on the introduction of new or repurposed assets and the lifecycle planning of those assets before installation and use.

In a first component in the example implementations, there is the operational condition which involves retrieving and consolidating operational requirement details, transforming current asset network analysis and planning models to current framework (e.g., data cleaning, and alignment), determining operational targets and limits (e.g., based on social metrics), building a survival curve based on historical operational condition, and building a survival forecast model and checking for validity.

In a second component in the example implementations, there is a scenario model which uses reliability laws to simulate the future scenarios in in fixed cycles per asset category and align to current re-eval time, builds asset changeover cycle scenarios, and defines the evaluation metric over key policy/performance indicators (KPIs) of organization by stakeholder.

Additional components, such as the circularity model, will also be described herein.

Aspects of the present disclosure can involve a method for management of a plurality of assets, involving a) executing a machine learning model to generate operational scenario-based event prediction from survival maps of the plurality of assets, historical data for the plurality of assets, and attributes of interest; b) receiving, from a plurality of stakeholders of the plurality of assets, weighted parameters for the attributes of interest associated with the operational-scenario-based event prediction; c) iterating a) and b) until a circularity decision is generated for the plurality of assets; and d) executing the circularity decision on the plurality of assets.

Aspects of the present disclosure can involve a computer program for management of a plurality of assets, involving instructions including a) executing a machine learning model to generate operational scenario-based event prediction from survival maps of the plurality of assets, historical data for the plurality of assets, and attributes of interest; b) receiving, from a plurality of stakeholders of the plurality of assets, weighted parameters for the attributes of interest associated with the operational-scenario-based event prediction; c) iterating a) and b) until a circularity decision is generated for the plurality of assets; and d) executing the circularity decision on the plurality of assets. The computer program and instructions can be stored on a non-transitory computer readable medium and executed by one or more processors.

### BRIEF DESCRIPTION OF THE DRAWINGS

FIG. 1 illustrates a system of the proposed circularity planning framework for asset management, in accordance with an example implementation.

FIG. 2 illustrates an example of the stakeholder at different planning phases, in accordance with an example implementation.

FIG. 3 illustrates graphs for the assets in the network, in accordance with an example implementation.

FIG. 4 illustrates an example method and process flow, in accordance with an example implementation.

FIGS. 5 to 7B illustrate the functional block diagrams for the data extraction, asset similarity mapping, and event processing for prediction and co-occurrence detection to scenario generations for the circularity choice model, in accordance with an example implementation.

FIG. 8 illustrates a functional diagram for a circularity decision influence diagram with regards to policy selection, in accordance with an example implementation.

FIG. 9 illustrates example sample output of the mobility asset management, in accordance with an example implementation.

FIG. 10 illustrates an example of a physical system overview, in accordance with an example implementation.

FIG. 11 illustrates an example flow for selection for circularity, in accordance with an example implementation.

FIG. 12 illustrates an example reference model for an asset stakeholder map, in accordance with an example implementation.

FIG. 13A illustrates an example of the scenario builder for risk-based planning for asset management, in accordance with an example implementation.

FIG. 13B illustrates an example of utilizing the scenario builder to determine survival probability and output desired KPIs in accordance with an example implementation.

FIG. 14 illustrates an example of the application design for the reinforcement learning techniques described herein, in accordance with an example implementation.

FIG. 15 illustrates a plurality of physical asset systems that are networked to a management apparatus, in accordance with an example implementation.

FIG. 16 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means or can be implemented through a desired algorithm. Example implementations as described herein can be utilized either singularly or in combination and the functionality of the example implementations can be implemented through any means according to the desired implementations.

The example implementations are related to a transportation asset management which conventionally include a network dissimilar asset with defined set system hierarchy (system-subsystem-parts breakdown as defined in record configuration management). The asset dissimilarity may arise from the design time system definitions or due to the generation design (hardware) and version controls (software) of product. Further, the transit assets in particular are remote and geographically distributed in nature. This makes the location-based definition to be a natural way of expression for the network of assets and hence used herein. Network definition imports data from maps, live maps, movable and immovable asset location when available and constrains such as flow direction, track definition, signal frequencies, speed limits associated with the asset for the given geographical location.

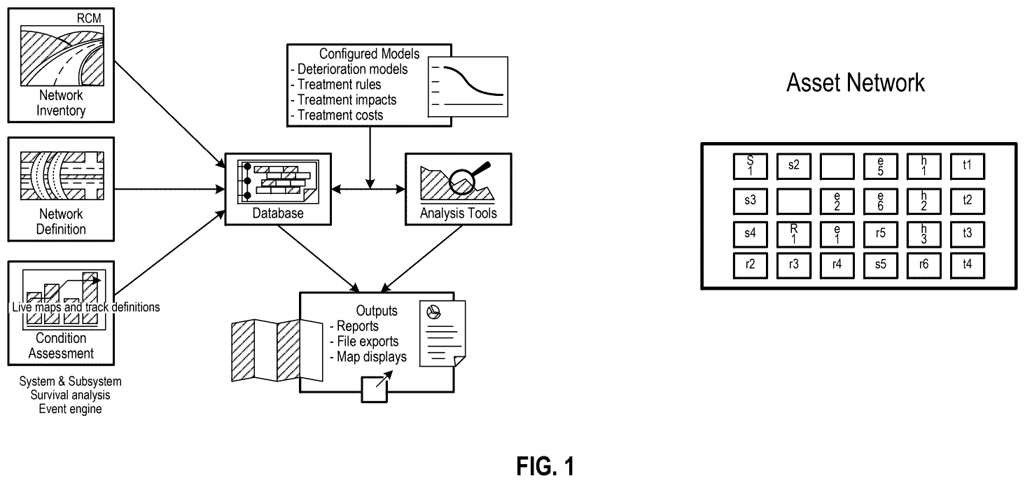

FIG. 1 illustrates a system of the proposed circularity planning framework for asset management, in accordance with an example implementation. The system proposed here also abstracts information of the asset conditions at both system and subsystem level, operational records, code-able human activity, and operational processes. Database with abstraction of asset network and related contextual external information like weather (forecast), regulatory updates etc. are used to build analysis tools required to estimate the asset survival probability at (i) part, (ii) sub-system, (iii) system and (iv) network level. The analysis tools take in set of treatment rules set by the asset managers which include scheduled maintenance time span, cost of part replacement, warranty and part rework, risk impact qualitative inputs. These units are used by the system to generate risk scenarios and propose choices for circularity model to choose from.

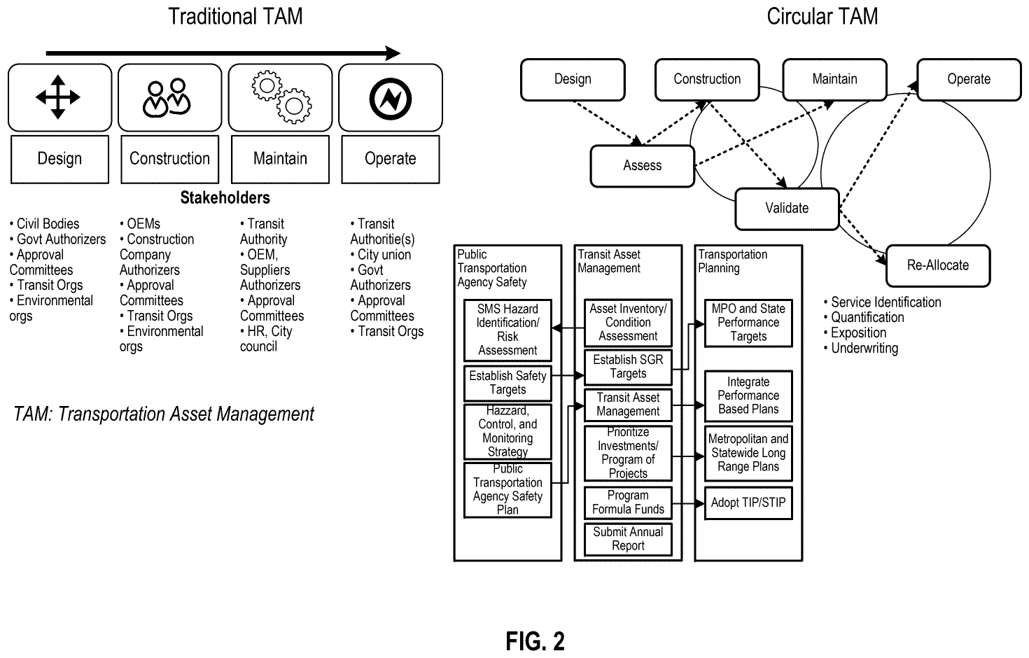

FIG. 2 illustrates an example of the stakeholder at different planning phases, in accordance with an example implementation. Specifically, FIG. 2 provides contrastive view of linear and circular asset management framework's stakeholders and their decision loops. Typically, in a linear chain the handoffs happen after each phase and the planning workflow is usually logged and would not require complex reauthorization cycle which might arise with a circular transportation asset management (TAM). The diagram also lists an example list of stakeholders involved at each stage of TAM and an example stakeholder specific planning actives in transit asset management.

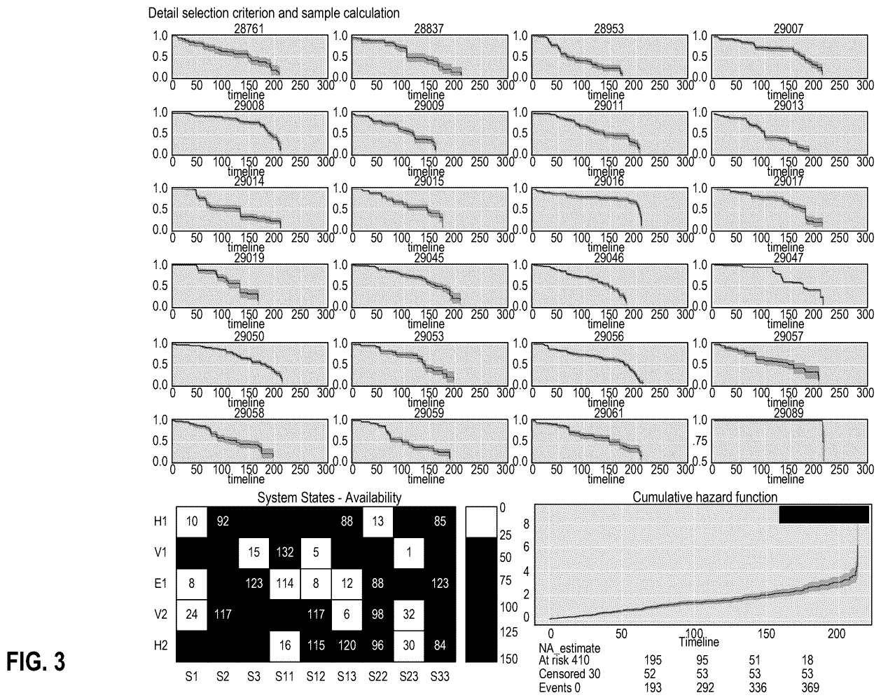

FIG. 3 illustrates various graphs for the assets in the network, in accordance with an example implementation. Specifically, FIG. 3 illustrates a unique asset condition graph for all the assets in the network, in accordance with an example implementation. Asset condition here is represented by a survival graph which provides the probability of survival for any asset at a given time based on the recorded set of past risk/failure events for the asset or a similar asset. As the probability of survival for an asset decreases asset manager is indicated that the one or more components in the network are bound to failure. However, the absolute probability of failure for each asset or asset type may vary depending on the operational conditions but this graph can be used to set a reference index to determine asset similarity and threshold for circulatory planning. FIG. 3 further illustrates the sample network of asset with system availability heat map which indicates condition of the networks at any given time. A higher reading on the heatmap indicate the network functionality is robust and risk of downtime is low and vice versa. Finally, FIG. 3 illustrates a graph that provides cumulative risk index.

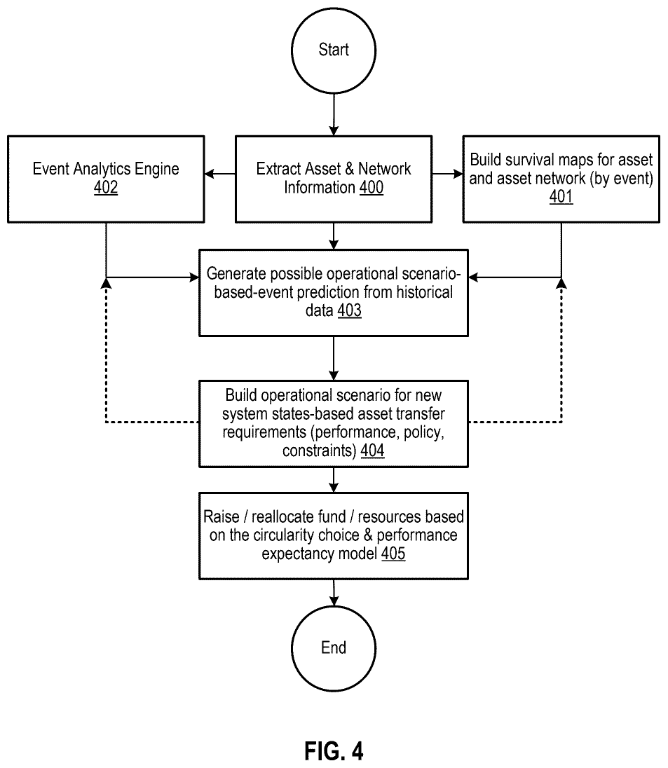

FIG. 4 illustrates an example method and process flow, in accordance with an example implementation. FIG. 4 provides details method and process flow which includes 5 step process.

At 400, the flow extracts operational data and sensor data associated with the asset network and parses it to build asset survival and asset similarity maps 401 across the network. The flow uses the event log to build a comprehensive event analytics engine 402 to provide prediction and transfer identification based on event list and asset similarity.

At 403, the flow builds an operational scenario-based event prediction from historical data. At 404, the flow builds an operational scenario for new system states-based asset transfer requirements (performance, policy, constraints). Subsequently, the inputs from possible operational scenario-based event prediction from 403 and the operational scenario for new system states-based asset transfer requirements from 404 are used to generate possible operational scenarios (via feedback to the event analytics engine 402) and associated system network availability heat maps (via feedback for building survival maps 401).

The above flow is iterated to estimate asset survival graphs based on predicted events and rate performance expectancy. The candidates for asset replacements are generated and then fund allocation is conducted based on the circularity choice model.

At 405, the flow then raises/reallocates funds/resources based on the circularity choice and the performance expectancy model.

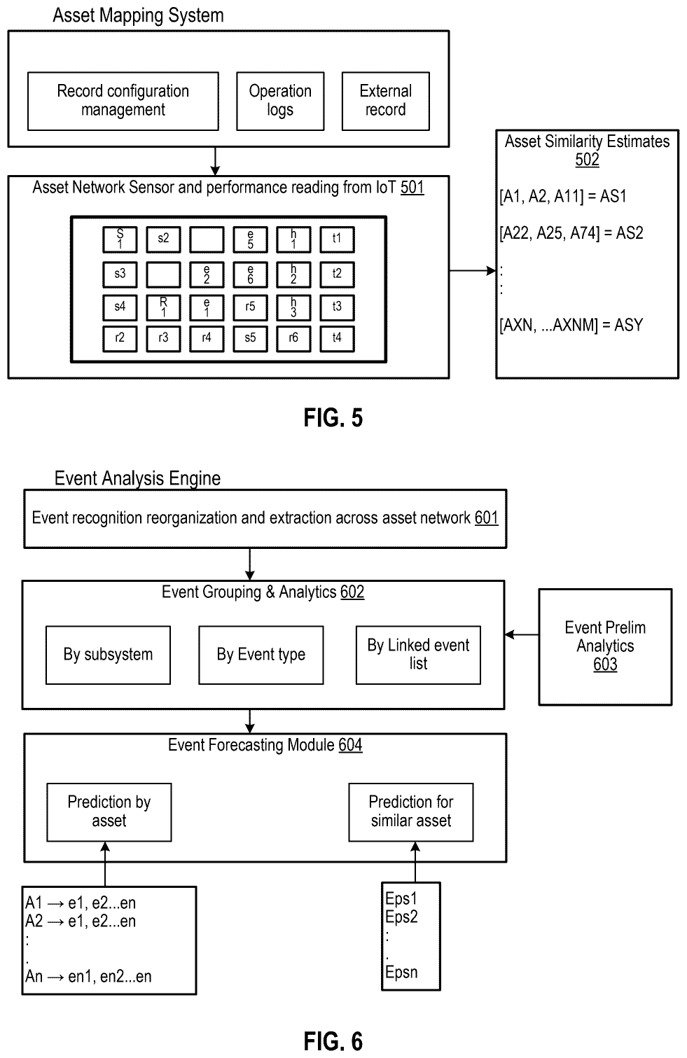

FIGS. 5 to 7B illustrate the functional block diagrams for the data extraction, asset similarity mapping, and event processing for prediction and co-occurrence detection to scenario generations for the circularity choice model, in accordance with an example implementation. The details of the methods and model are provided as follows.

The first step towards circularity planning is asset selection. This is done here based on asset records and system hierarchy information extracted from TAM database. Asset selection is conducted for building the attribute list to generate asset survival graphs for all assets in the system based operational parameters such as time, cost of project and sensor inputs associated with the asset network. Based on the survival graph generated from these inputs, asset similarity mapping is performed as illustrated in FIG. 5. In the asset mapping system as illustrated in FIG. 5, operation logs and other records are provided to the asset network sensor and performance reading from the IoT system 501 to determine asset similarity estimates 502.

Similarity mapping can be achieved either using matching range of Weibull coefficients of the survival graph associated with assets in a simple network or the same can be achieved using unsupervised machine learning models that cluster the assets based on their variable performance curves. One of the main advantages of the latter approach is the data-based models allows for establishment of dynamic group memberships which are otherwise not possible with the parametric approaches.

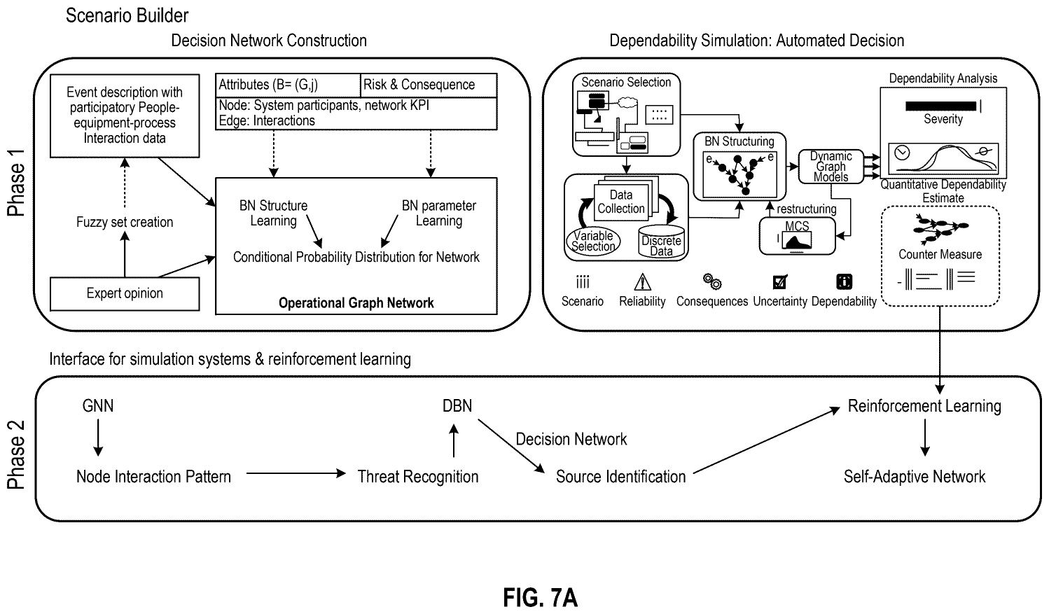

Following the asset similarity mapping, the event analytics engine as illustrated in FIG. 6 provides a multi-event forecast for the asset and asset groups mapped earlier based on the performance similarity. The performance similarity is used to generate discrete system states as described below.

If a discrete time stochastic process Xₜ, t=0, 1, 2, . . . is represented by a state space S, such that S={0, 1, 2, . . . , Ns−1} or {1, 2, . . . , Nₛ}, then for all i and j in S, the relationship in Equation (1) holds for a time homogeneous process

$$P \{ ( {X}_{t + 1} = j \vert {X}_{t = i} , {X}_{t - 1} , … , {X}_{0} ) = P ( {X}_{t + 1} = j \vert {X}_{t = i} ) \} \qquad ( 1 )$$

For a finite action set A={a₁, a₂, . . . , an} and discrete time points to, t₁, t₂, tᵢ, tᵢ₊₁, . . . , the future state of the stochastic process Xₜ₊₁ is independent of the previous states X₀, X₁, . . . , Xₜ₋₁ but depends only on Xₜ and can be written as shown in Equation (2) for a 1-step stochastic processes.

$${P}_{{i}^{′} , {j}^{′}}^{m} = {[ \begin{matrix}{P}_{1 , 1}^{m} & {P}_{1 , 2}^{m} & … & {P}_{1 , Ns}^{m} \\ {P}_{2 , 1}^{m} & {P}_{2 , 2}^{m} & … & {P}_{2 , Ns}^{m} \\ ⋮ & ⋮ & ⋱ & ⋮ \\ {P}_{{N}_{s} , 1}^{m} & {P}_{{N}_{s} , 2}^{m} & … & {P}_{{N}_{s} , {N}_{s}}^{m}\end{matrix} ]}_{∀ {i}^{′} , {j}^{′} ϵ S , a ϵ A , t = 1 , 2 , ...} \qquad ( 3 )$$

where P⁽¹⁾(j|i,a) is the probability of a 1-step Markov process that the next state is in j at time t+1 and the current state is in i and the action a is taken at time t.

For an m-step transition matrix with next state j′ at a time t+1 and action a is taken at current state i′ and time t (Equation (3)), to be a stochastic matrix, the relationship in Equation (4) will hold, since there will be no inherent negative values in the Markov processes

$${P}^{( 1 )} ( j \vert i , a ) = P ( {X}_{t + 1} = j \vert {X}_{t = i} , {A}_{t} = a ) ∀ i , j ϵ Xt , a ϵ A , t = 1 , 2 , \qquad ( 2 )$$

As illustrated in FIG. 6, the Event Analysis Engine processes event recognition reorganization and extraction across the asset network at 601 to feed into the event grouping and analytics 602. The event grouping and analytics 602 further receives event prelim analytics 603 to group the events depending on the desired implementation (e.g., by subsystem, by event type, by linked event list, etc.). Based on the event grouping and analytics, the event forecasting module 604 can thereby issue predictions of events by assets or by similar assets.

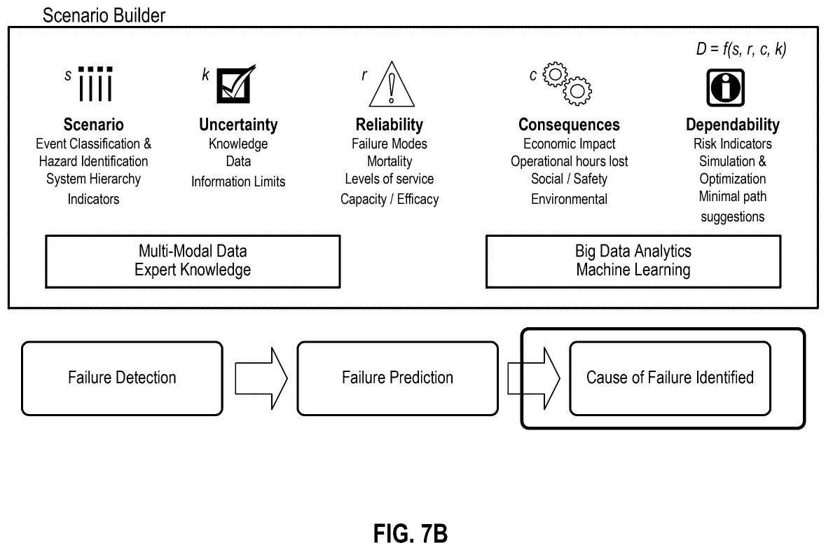

FIG. 7A illustrates the example scenario builder, in accordance with an example implementation. In the example of FIG. 7A, a possible scenarios list with system availability hierarchy optimization methods is generated, so that the end user can choose the assets for circularity replacement/investment on reallocation.

General TAM financial models are based on a quantity-based allocation model. This allows for optimally allocating capacity of resources to demand by controlling the availability of fare products. This allocation is done dynamically as demand materializes, and with considerable uncertainty about the quantity or composition of future requests. The problem arises because of the assumption that demand for each class is an independent stochastic process that is not influenced by the availability controls. This so-called independent demand/availability model does not endogenize usage pattern in circularity, such as choice behavior and purchase-timing behavior

### Choice Behavior: Attribute Definitions

Choice Behavior: Attribute Definitions

| Attribute | Description | Value |
|---|---|---|
| Xₙ₀ | Base Performance | Hazzard Rate *1000 |
| Xₙ₁ | Service level 1 | W^{tarrival-event rate} * hazard |
| | | rate for relocation |
| . | Service level 2 | |
| . | . . . | |
| Xₙ₀ | Indicator of serviceability | |
| | (value prop after n cycles). | |

Choice Model design can be attained based from the Incomplete Data Log-Likelihood Function using EM methods or other multi-objective optimization methods like genetic algorithm to generate a list of assets and a sub-system list for circularity planning and the associated fund allocation.

FIG. 7B illustrates another aspect of the scenario builder for constructing a module to determine the cause of failure for a detected failure in accordance with an example implementation. In this example dependability is learned as a function involving scenario, uncertainty, reliability, and consequences to determine causes of failure, which can include training against multi-modal data across all fields of interest along with corresponding expert knowledge. Scenario can include an event classification and hazard identification model that utilizes system hierarchy indicators to determine the events and hazard. Uncertainty can involve knowledge, data and information limits. Reliability can include failure modes of the underlying types assets, mortality data of historical assets, consequences of the failure of assets such as economic impact, operational hours lost, social or safety costs, as well as environmental costs. The dependability function can intake risk indicators, execute simulation and optimization and provide minimal path suggestions.

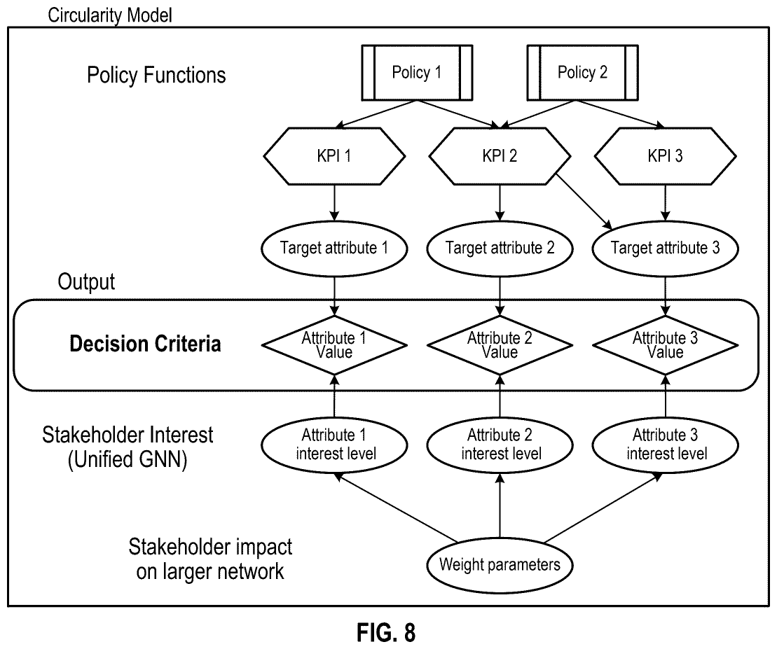

FIG. 8 illustrates a functional diagram for a circularity decision influence diagram with regards to policy selection, in accordance with an example implementation. Specifically, FIG. 8 illustrates example of sample output from each module of the systems which can be used by the different stakeholder of the asset management. As shown in the circularity model, stakeholders provide weight parameters on attributes of interest to determine the interest levels across a plurality of attributes. To determine values for those plurality of attributes of interest, the policy functions determine KPIs for the target attributes to determine the values of the target attributes.

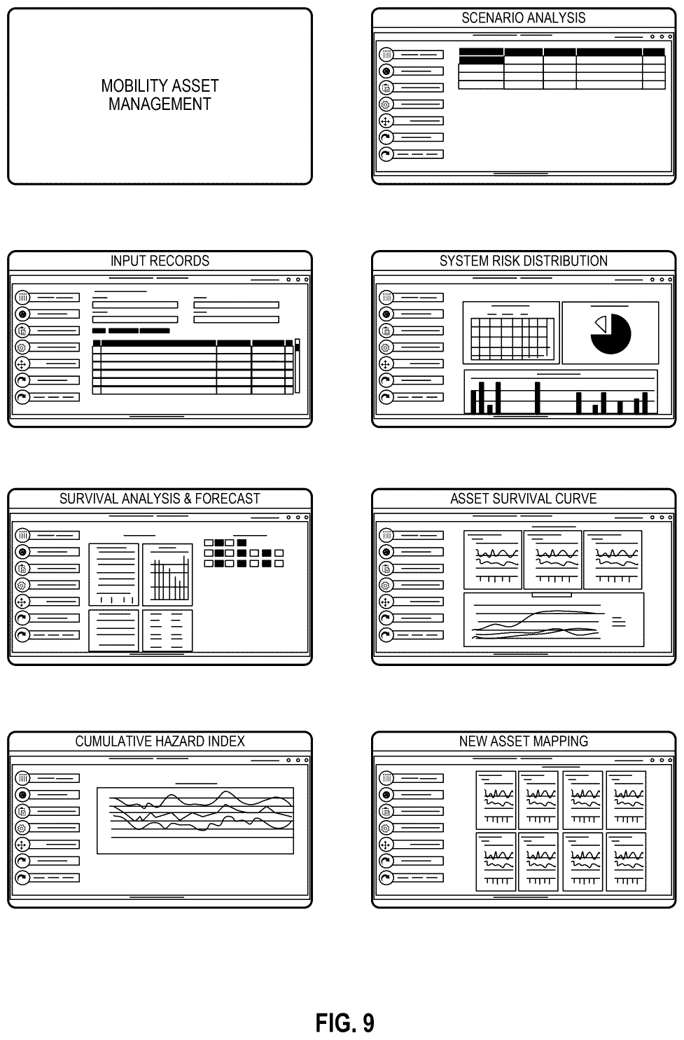

FIG. 9 illustrates example sample output of the mobility asset management, in accordance with an example implementation. Various interfaces for the mobility asset management can be generated for stakeholder review, which can include, but is not limited to, scenario analysis, input records, system risk distribution, survival analysis and forecast, asset survival curves, cumulative hazard index, as well as new asset mapping.

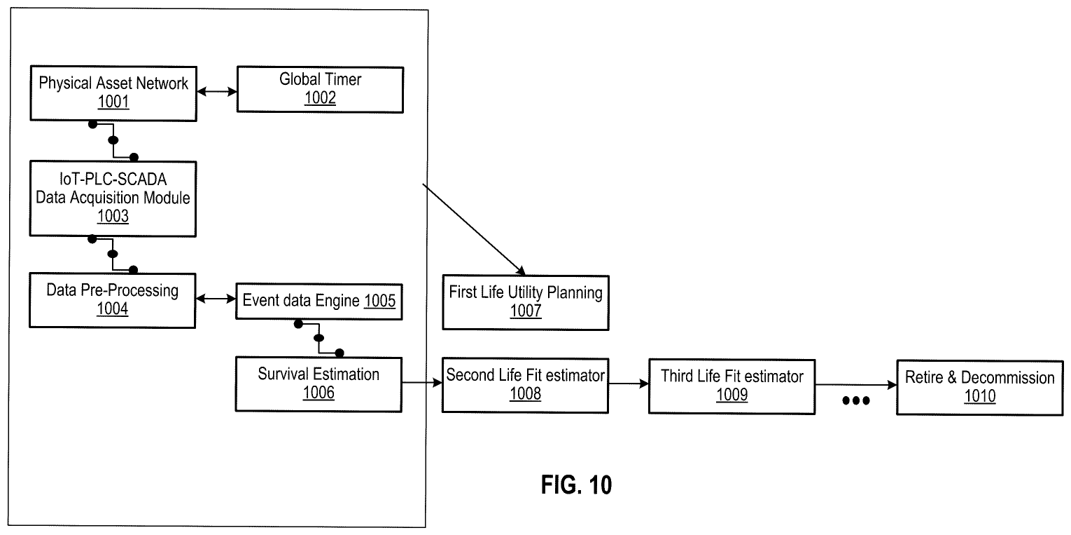

FIG. 10 illustrates an example of a physical system overview, in accordance with an example implementation. The physical asset network 1001 can include a plurality of assets that are connected to each other via a network, and can be associated with a global timer 1002 which can be utilized to monitor the aging of the assets for the survival estimation 1006. Physical asset network can be configured to provide data to a management apparatus through a corresponding Internet of Things/Programmable Logical Controller/SCADA Data Acqusition Module 1003. Such data undergoes data pre-processing 1004 to be put into the event data engine 1005 to determine the survival estimation 1006 of the assets under management.

The system can be utilized to determine first life utility planning 1007 to determine the progression of the asset until maintenance or shutdown is required to extend the life of the underlying asset. Once the asset undergoes a life extension process, then the system can be utilized to determine the second life estimation 1008, third life estimation 1009, until the asset undergoes a retirement and decommission 1010.

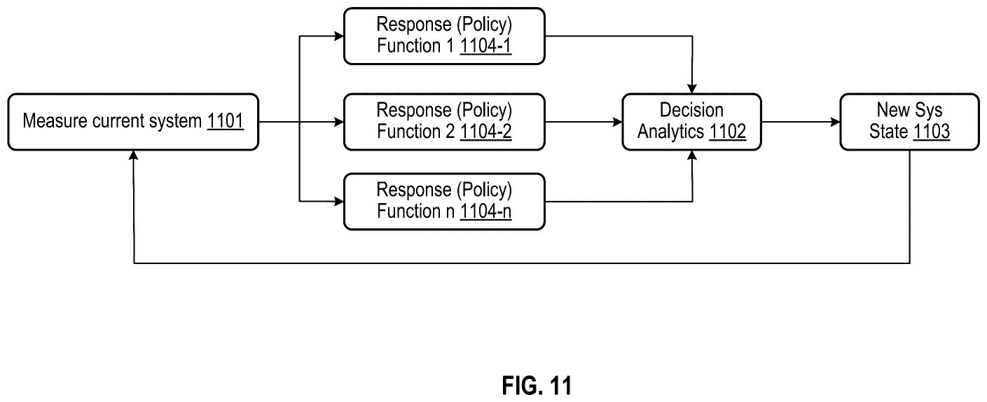

FIG. 11 illustrates an example flow for selection for circularity, in accordance with an example implementation. In an example implementation the current system is measured at 1101 based on the sensor data, global timer, and other data of the underlying assets. The data is then put through a series of response/policy functions 1104-1, 1104-2, 1104-n, which provides output of values for key attributes to be used in decision analytics 1102. Decision analytics 1102 can then use the value of the key attributes for processing by the underlying reinforcement learning model to produce a new system state 1103 for the underlying assets (e.g., maintenance, shutdown, changing settings of asset, etc.).

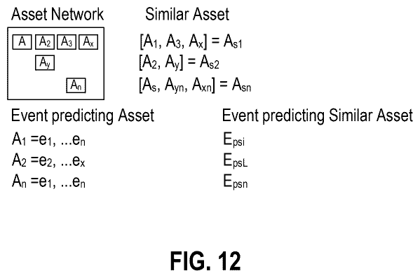

FIG. 12 illustrates an example reference model for an asset stakeholder map, in accordance with an example implementation. The assets in the asset network can be grouped together by similar assets. Each of the assets can have events predicting specific states of the asset. Such information can also be used to derive events predict similar assets based on the determined similar assets.

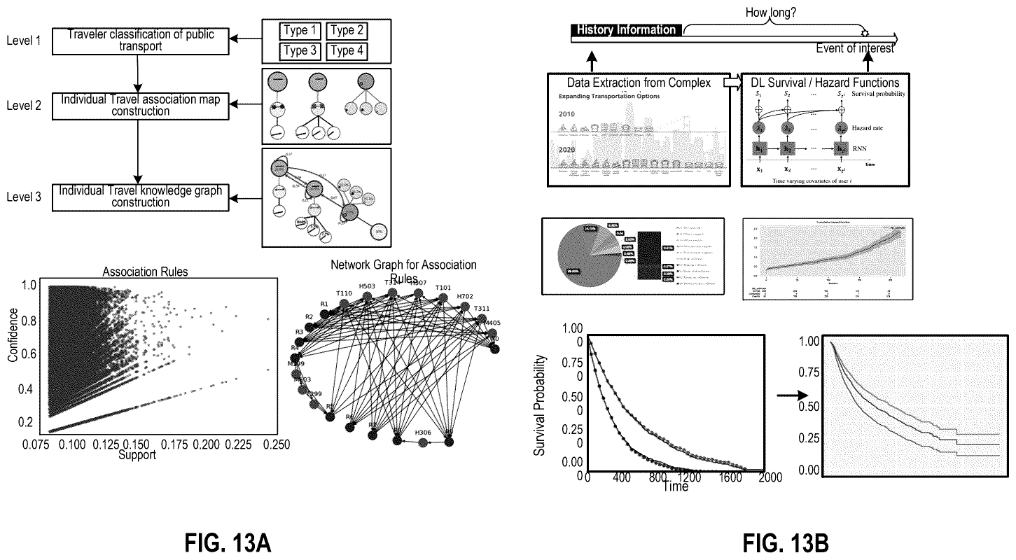

FIG. 13A illustrates an example of the scenario builder for risk-based planning for asset management, in accordance with an example implementation. As shown in the example of FIG. 13A, at first, the types of transport (e.g., public transport) are classified for the travelers of a particular system at the first level. At the next level, based on the routes taken by travelers, an individual travel association map is constructed across the multiple modes of transport to determine which types of travel are associated with each other (e.g., travelers who take a train may also take a bus afterwards). At the third level, the individual travel knowledge graph is constructed to determine the associations between the multi-modes of transport. The levels can be executed by the scenario builder to determine the association rules as well as the network graph for association rules as illustrated in FIG. 13A. Although the example described herein involves transport, other linked asset systems (e.g., factory floors, IoT systems) can also be utilized and the present disclosure is not limited thereto.

FIG. 13B illustrates an example of utilizing the scenario builder to determine survival probability and output desired KPIs in accordance with an example implementation. Based on historical information, as well as the association rules and the network graph, data can be extracted from a time period before an event of interest to the event of interests (e.g., accidents, failures, etc.) to execute reinforcement learning for determining survival and hazard functions. The reinforcement learning algorithms can be trained to determine a survival probability of an asset over time which can be provided to the user. Further, values of other desired KPIs may also be derived from the historical data, such as system availability, component reliability/survival time, hazard rates, risk probability, second life planning, and so on.

Through such an example implementation, rare event embeddings as well as long/short term risk event prediction can be facilitated once the association rules and the network graph can be produced. Further, the example implementations described herein can thereby facilitate out of distribution detection and generalization, as well as asset similarity identification. Based on the asset similarity identification, model transferability between different assets or different types of assets can also be derived.

In addition, such example implementations can be executed on live systems to intake system activity and update survival probabilities for assets in accordance with the desired implementation. Through such example implementations, the managers of such multi-asset systems can

Further, through such example implementations, the knowledge graph of mobility events (e.g., map to routes, travel patterns) can be derived, upon which various KPIs can therefore be derived, such as time to failure, a failure composition map, an accident/incident classification log, and so on.

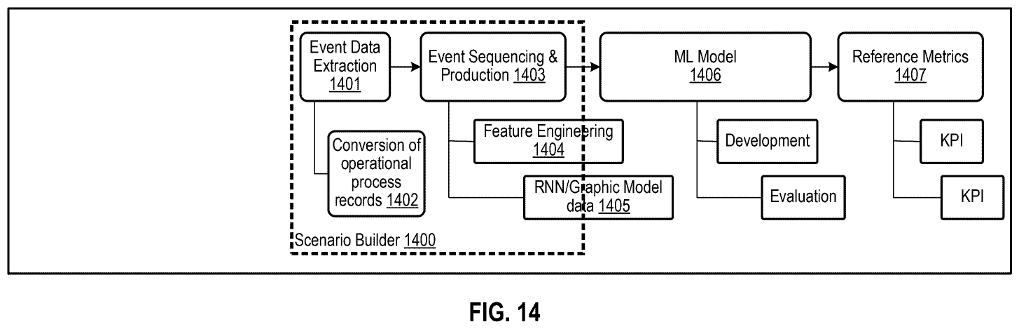

FIG. 14 illustrates an example of the application design for the reinforcement learning techniques described herein, in accordance with an example implementation. Depending on the desired implementation, various levels risk-based planning for asset management can be trained using the techniques described herein to facilitate the desired implementation, such as, but not limited to risk identification, prediction and decomposition, propagation and impact, as well as dynamic planning.

In the scenario builder 1400, once the types of assets, association rules, and the network graph are obtained through the example implementations illustrated in FIG. 13A, the scenario builder can proceed to conduct event data extraction 1401 as illustrated in FIG. 13B to extract events from historical data. Such event data extraction 1401 can involve the conversion of operational process records 1402 into a data format that can be processed by the machine learning model. Once the data is extracted, it can be processed through an event sequencing and production 1403 process that can be configured to conduct feature engineering 1404 to extract desired features as well as to derive recurrent neural network data or graphic model data 1405.

Once the data is processed, it can be provided to a machine learning model 1406 such as a reinforcement learning model to undergo development and evaluation. Such a machine learning model 1406 can be configured to conduct structure learning as well as parameter learning. As described herein, the machine learning model 1406 can involve reinforcement learning that is configured to learn survival probability as well as desired KPIs. Once the machine learning model 1406 is trained, then it can produce desired reference metrics 1407 as output, such as the desired KPIs or survival probability.

Example implementations described herein can thereby facilitate systems and methods to address the key requirements in transportation asset management which include fund accountability and transgression policy, asset procurement planning (usage compliance plan generation), Asset-circularity decision (Sustainable utilization), as well as capital allocation and re-allocation (Performance based fund allocation proofs generation).

Through the example implementations described herein, asset circularity plan cognization of the current and future operational requirements can be realized.

Through the example implementations described herein, circularity planning can be done in line with the capital allocation planning, thereby making the asset records and requirements documentation simple with all-in-one place approach.

Through the example implementations described herein, a plug and play kind of ease of operation can be provided, making it easy to update models and get the set of related operational entity planning that need to be updated.

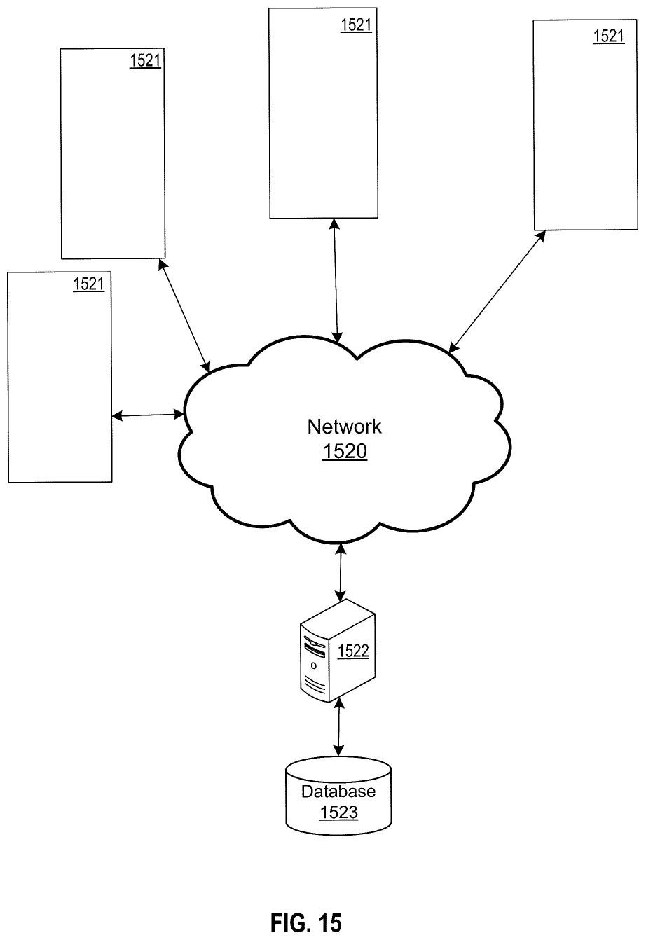

FIG. 15 illustrates a plurality of physical asset systems that are networked to a management apparatus, in accordance with an example implementation. One or more physical asset systems 1521 (e.g., air compressors, lathes, trains, buses, server systems, etc.) involve physical machines that are communicatively coupled to a network 1520 (e.g., local area network (LAN), wide area network (WAN)) through the corresponding network interface of the sensor system installed in the physical asset systems 1521, which is connected to a management apparatus 1522 configured to facilitate the functionality of the maintenance work support system 600 for supporting maintenance work on a machine of the physical asset systems 1521. The one or more physical asset systems 1521 may or may not be associated with sensors, depending on the desired implementation. The management apparatus 1522 manages a database 1523, which contains historical data collected from the sensor systems from each of the physical asset systems 1521. In alternate example implementations, the data from the sensor systems of the physical asset systems 1521 can be stored in a central repository or central database such as proprietary databases that intake data from the physical asset systems 1521, or systems such as enterprise resource planning systems, and the management apparatus 1522 can access or retrieve the data from the central repository or central database. The sensor systems of the physical asset systems 1521 can include any type of sensors to facilitate the desired implementation and provide internal status machine data, such as but not limited to gyroscopes, accelerometers, global positioning satellite (GPS), thermometers, humidity gauges, or any sensors, and so on. As described herein, the management apparatus 1522 can also be connected to one or more cameras (not illustrated) that are monitoring the external status of the machines of the one or more physical asset systems 1521.

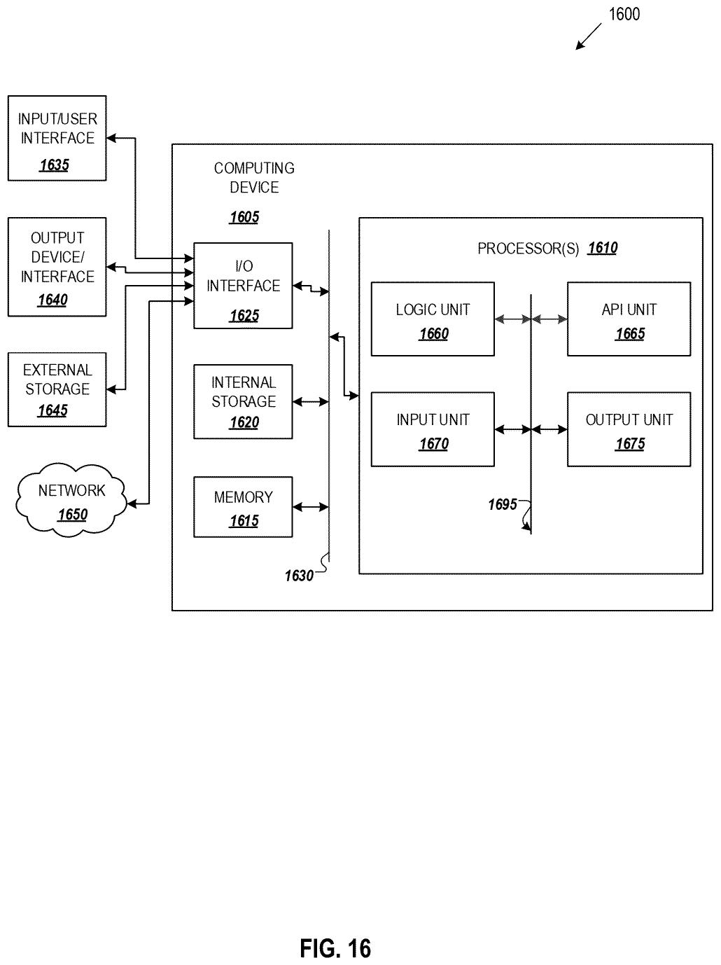

FIG. 16 illustrates an example computing environment with an example computer device suitable for use in some example implementations, such as the management apparatus 1522. Computer device 1605 in computing environment 1600 can include one or more processing units, cores, or processors 1610, memory 1615 (e.g., RAM, ROM, and/or the like), internal storage 1620 (e.g., magnetic, optical, solid state storage, and/or organic), and/or I/O interface 1625, any of which can be coupled on a communication mechanism or bus 1630 for communicating information or embedded in the computer device 1605. I/O interface 1625 is also configured to receive images from cameras or provide images to projectors or displays, depending on the desired implementation.

Computer device 1605 can be communicatively coupled to input/user interface 1635 and output device/interface 1640. Either one or both of input/user interface 1635 and output device/interface 1640 can be a wired or wireless interface and can be detachable. Input/user interface 1635 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1640 may include a display, television, monitor, printer, speaker, braille, or the like. In some example implementations, input/user interface 1635 and output device/interface 1640 can be embedded with or physically coupled to the computer device 1605. In other example implementations, other computer devices may function as or provide the functions of input/user interface 1635 and output device/interface 1640 for a computer device 1605.

Examples of computer device 1605 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1605 can be communicatively coupled (e.g., via I/O interface 1625) to external storage 1645 and network 1650 for communicating with any number of networked components, devices, and systems, including one or more computer devices of the same or different configuration. Computer device 1605 or any connected computer device can be functioning as, providing services of, or referred to as a server, client, thin server, general machine, special-purpose machine, or another label.

I/O interface 1625 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1600. Network 1650 can be any network or combination of networks (e.g., the Internet, local area network, wide area network, a telephonic network, a cellular network, satellite network, and the like).

Computer device 1605 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 1605 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1610 can execute under any operating system (OS) (not shown), in a native or virtual environment. One or more applications can be deployed that include logic unit 1660, application programming interface (API) unit 1665, input unit 1670, output unit 1675, and inter-unit communication mechanism 1695 for the different units to communicate with each other, with the OS, and with other applications (not shown). The described units and elements can be varied in design, function, configuration, or implementation and are not limited to the descriptions provided. Processor(s) 1610 can be in the form of hardware processors such as central processing units (CPUs) or in a combination of hardware and software units.

In some example implementations, when information or an execution instruction is received by API unit 1665, it may be communicated to one or more other units (e.g., logic unit 1660, input unit 1670, output unit 1675). In some instances, logic unit 1660 may be configured to control the information flow among the units and direct the services provided by API unit 1665, input unit 1670, output unit 1675, in some example implementations described above. For example, the flow of one or more processes or implementations may be controlled by logic unit 1660 alone or in conjunction with API unit 1665. The input unit 1670 may be configured to obtain input for the calculations described in the example implementations, and the output unit 1675 may be configured to provide output based on the calculations described in example implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for management of a plurality of assets, comprising:
a) executing a machine learning model to generate operational scenario-based event prediction from survival maps of the plurality of assets, historical data for the plurality of assets, and attributes of interest;
b) receiving, from a plurality of stakeholders of the plurality of assets, weighted parameters for the attributes of interest associated with the operational-scenario-based event prediction;
c) iterating a) and b) until a circularity decision is generated for the plurality of assets; and
d) executing the circularity decision on the plurality of assets.

2. The method of claim 1, further comprising training the machine learning model to generate operational scenario-based event prediction from historical data, asset maps indicating similarity of assets, and event analytics conducted on the historical data to group events for the assets according to the similarity.

3. The method of claim 1, wherein the machine learning model is executed for the plurality of assets in real time, wherein the survival maps are updated in real time in response to data provided from the plurality of assets.

4. The method of claim 1, wherein the executing the circularity decision on the plurality of assets comprises retiring and decommissioning assets indicated to be retired by the circularity decision.

5. The method of claim 1, wherein the executing the circularity decision comprises scheduling maintenance from an asset according to the circularity decision and generating an updated survival map for the asset upon completion of the maintenance.

6. A non-transitory computer readable medium, storing instructions for executing a process for management of a plurality of assets, the instructions comprising:
a) executing a machine learning model to generate operational scenario-based event prediction from survival maps of the plurality of assets, historical data for the plurality of assets, and attributes of interest;
b) receiving, from a plurality of stakeholders of the plurality of assets, weighted parameters for the attributes of interest associated with the operational-scenario-based event prediction;
c) iterating a) and b) until a circularity decision is generated for the plurality of assets; and
d) executing the circularity decision on the plurality of assets.

7. The non-transitory computer readable medium of claim 6, further comprising training the machine learning model to generate operational scenario-based event prediction from historical data, asset maps indicating similarity of assets, and event analytics conducted on the historical data to group events for the assets according to the similarity.

8. The non-transitory computer readable medium of claim 6, wherein the machine learning model is executed for the plurality of assets in real time, wherein the survival maps are updated in real time in response to data provided from the plurality of assets.

9. The non-transitory computer readable medium of claim 6, wherein the executing the circularity decision on the plurality of assets comprises retiring and decommissioning assets indicated to be retired by the circularity decision.

10. The non-transitory computer readable medium of claim 6, wherein the executing the circularity decision comprises scheduling maintenance from an asset according to the circularity decision and generating an updated survival map for the asset upon completion of the maintenance.

11. An apparatus for executing a process for management of a plurality of assets, the apparatus comprising:
a processor, configured to:
a) execute a machine learning model to generate operational scenario-based event prediction from survival maps of the plurality of assets, historical data for the plurality of assets, and attributes of interest;
b) receive, from a plurality of stakeholders of the plurality of assets, weighted parameters for the attributes of interest associated with the operational-scenario-based event prediction;
c) iterate a) and b) until a circularity decision is generated for the plurality of assets; and
d) execute the circularity decision on the plurality of assets.

12. The apparatus of claim 11, the processor further configured to train the machine learning model to generate operational scenario-based event prediction from historical data, asset maps indicating similarity of assets, and event analytics conducted on the historical data to group events for the assets according to the similarity.

13. The apparatus of claim 11, wherein the machine learning model is executed for the plurality of assets in real time, wherein the survival maps are updated in real time in response to data provided from the plurality of assets.

14. The apparatus of claim 11, wherein the processor is configured to execute the circularity decision on the plurality of assets by retiring and decommissioning assets indicated to be retired by the circularity decision.

15. The apparatus of claim 11, wherein the processor is configured to execute the circularity decision by scheduling maintenance from an asset according to the circularity decision and generating an updated survival map for the asset upon completion of the maintenance.
